(19) United States
(12) Patent Application Publication
(10) Pub. No.: US 2011/0150455 A1
(43) Pub. Date: Jun. 23, 2011

(54) OPTICAL DEVICE AND METHOD OF MOVING LENS THEREOF

(75) Inventors: Cheng-Kung TSAI, Taichung (TW); Mei Hua Chen, Taichung (TW)

(73) Assignee: ASIA OPTICAL CO., INC., Taichung (TW)

(21) Appl. No.: 12/969,911

(22) Filed: Dec. 16, 2010

(30) Foreign Application Priority Data
Dec. 16, 2009 (TW) 98143080

(51) Int. Cl. G02B 7/02; G03B 5/02; G03B 5/04

(52) U.S. Cl. 396/439; 359/814; 353/101

(57) ABSTRACT

An optical device includes a lens, a horizontal transmission module, a vertical transmission module, a horizontal driving unit, a vertical driving unit, a horizontal orientation detector, a vertical orientation detector, a user interface, and a control unit. The horizontal driving unit moves the lens horizontally via the horizontal transmission module. The horizontal orientation detector can detect horizontal movement of the lens and emit a horizontal sensing signal. The vertical driving unit can move the lens vertically via the vertical transmission module. The vertical orientation detector can detect vertical movement of the lens and emit a vertical sensing signal. The user interface can generate an operation signal. The control unit can control movement of the lens according to the operation signal, the horizontal sensing signal, and the vertical sensing signal.

### BACKGROUND OF THE INVENTION

1. Field of the Invention

The present invention relates generally to an optical apparatus, and more particularly, to an optical device and a method of moving its lens.

2. Description of the Related Art

In a conventional optical device as disclosed in Taiwan Patent Pub. No. 200905354, the movement of its lens is controlled by a stepping motor. Although the stepping motor controls the movement more easily, the power output of the stepping motor is lower than that of the general DC motor, such that when the stepping motor is installed in an optical device, like a projector, its power is not enough to move a high-definition (HD) glass lens thereof. Thus, the aforesaid conventional mechanism is not applicable to the high-end projectors.

### SUMMARY OF THE INVENTION

The primary objective of the present invention is to provide an optical device, which lens can be moved via its motor of greater power output.

The foregoing objective of the present invention is attained by the optical device composed of a lens, a horizontal transmission module, a vertical transmission module, a horizontal driving unit, a vertical driving unit, a horizontal orientation detector, a vertical orientation detector, a user interface, and a control unit. The horizontal driving module can drive the lens to move along a horizontal direction through the horizontal transmission module. The horizontal orientation detector can detect horizontal movement amount of the lens and then emit a horizontal sensing signal. The vertical driving unit can drive the lens to move along a vertical direction. The vertical orientation detector can detect vertical movement amount of the lens and then emit a vertical sensing signal. The user interface can emit an operation signal. The control unit controllably moves the lens according to the operation signal, the horizontal sensing signal, and the vertical sensing signal.

In light of the above, the optical device can move the HD glass lens via the DC motor of greater power, such that it can be applied to the high-end projectors. In the meantime, the DC motor is low-cost, so the product of the present invention is competitive in the market.

### BRIEF DESCRIPTION OF THE DRAWINGS

FIG. 1 is a block diagram of a first preferred embodiment of the present invention.

FIG. 2 is a schematic view of a part of the first preferred embodiment of the present invention, showing the detailed structure of the horizontal transmission module and the horizontal driving unit.

FIG. 3 shows the movable range and safe range of the lens in accordance with the first preferred embodiment of the present invention.

FIG. 4 shows the user interface in accordance with the first preferred embodiment of the present invention.

FIG. 5 is a rough flow chart of the method of moving the lens in accordance with a second preferred embodiment of the present invention.

FIG. 6 is a detailed flow chart of the method of moving the lens in accordance with the second preferred embodiment of the present invention.

### DETAILED DESCRIPTION OF PREFERRED EMBODIMENTS

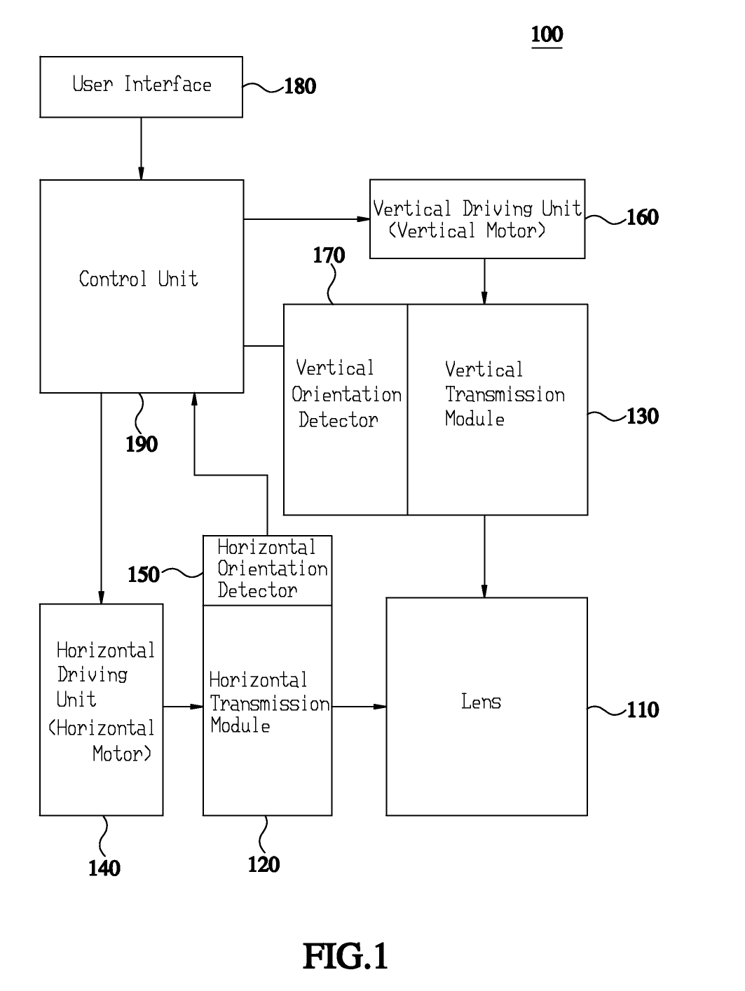

Referring to FIG. 1, an optical device 100 constructed according to a first preferred embodiment of the present invention is composed of a lens 110, a horizontal transmission module 120, a vertical transmission module 130, a horizontal driving unit (horizontal motor) 140, a horizontal orientation detector 150, a vertical driving unit (vertical motor) 160, a vertical orientation detector 170, a user interface 180, and a control unit 190. The detailed descriptions and operations of these elements as well as their interrelations are recited in the respective paragraphs as follows.

The horizontal transmission module 120 is connected with the lens 110. The vertical transmission module 130 is connected with the lens 110. The horizontal driving unit 140 is connected with the horizontal transmission module 120. The horizontal driving unit 140 can drive the lens 110 to move along a horizontal direction through the horizontal transmission module 120. The horizontal orientation detector 150 can detect horizontal movement amount of the lens 110 and then emit a horizontal sensing signal. The vertical driving unit 160 is connected with the vertical transmission module 130 and can drive vertical movement of the lens 110 through the vertical transmission module 130. The vertical orientation detector 170 can detect vertical movement amount of the lens 110 and then emit a vertical sensing signal. The user interface 180 can emit an operation signal. The control unit 190 is electrically connected with the user interface 180, the horizontal orientation detector 150, the vertical orientation detector 170, the horizontal driving unit 140, and the vertical driving unit 160. The control unit 190 can control the movement of the lens 110 according to the operation signal, the horizontal sensing signal, and the vertical sensing signal.

In this embodiment, the horizontal driving unit 140 includes a DC motor. The vertical driving unit 160 includes a DC motor. Each of the horizontal and vertical orientation detectors 150 and 170 is a rotary encoder. The horizontal orientation detector 150 is connected with the horizontal transmission module 120. The vertical orientation detector 170 is connected with the vertical transmission module 130.

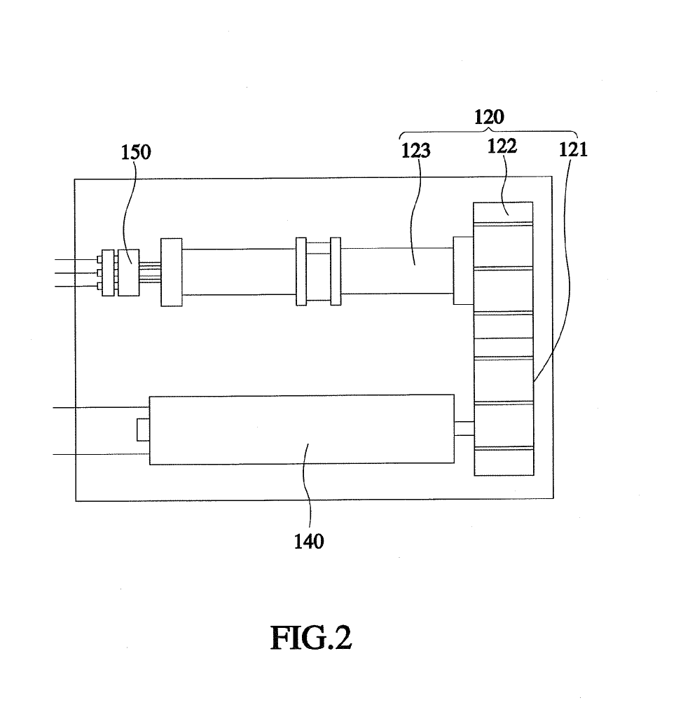

Referring to FIG. 2, the horizontal transmission module 120 includes gears 121 and 122 and a screw rod 123. The horizontal driving unit 140 is connected with the gear 121 for driving the horizontal transmission module 120 to move thereby. The horizontal orientation detector 150 is mounted to one end of the screw rod 123. While detecting the screw rod 123, the horizontal orientation detector 150 outputs square waves of potential variations. According to times of the potential variations, the control unit 190 can get rotational amount of the screw rod 123, which can be converted into the horizontal movement amount of the lens 110. In one embodiment, the control unit 190 can get the horizontal coordinate of the lens 110 from the sum of a variant of horizontal position plus/minus the times of potential variations. The vertical transmission module and the vertical driving unit are structurally identical to the horizontal transmission module and the horizontal driving unit separately. Besides, how to detect the vertical movement amount and vertical coordinate of the lens is identical to that of the horizontal movement amount and horizontal coordinate thereof Alternatively, the horizontal orientation detector 150 can be mounted on the horizontal driving unit 140 and similarly, the vertical orientation detector 170 can be mounted on the vertical driving unit 160.

As indicated above, the control unit 190 can calculate a coordinate (horizontal or vertical), e.g. x-y coordinates, and then the coordinate is inputted into a boundary control equation, e.g. x-y equation. When the coordinate satisfies the boundary control equation, the control unit 190 refrains the horizontal driving unit 140 or the vertical driving unit 160 from action to prevent the lens 110 from collision.

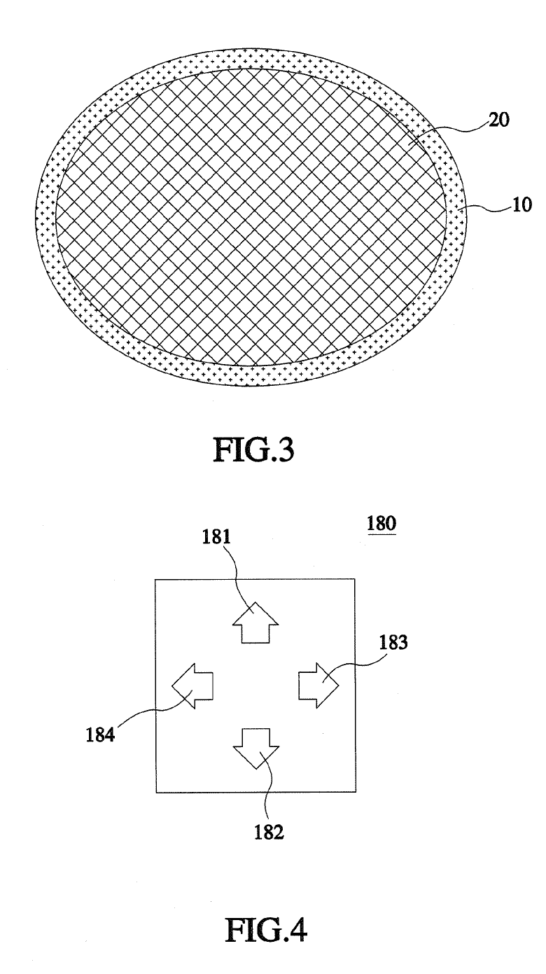

Referring to FIG. 3, the boundary control equation sets a safe range 20 via the movable range 10 of the lens 110 to prevent the lens 110 from colliding with the border of the movable range 10. The safe range 20 can be acquired straight by mathematics. The boundary control equation defines the edge of the safe range 20.

Referring FIG. 4, the user interface 180 includes an up key 181, a down key 182, a left key 183, and a right key 184.

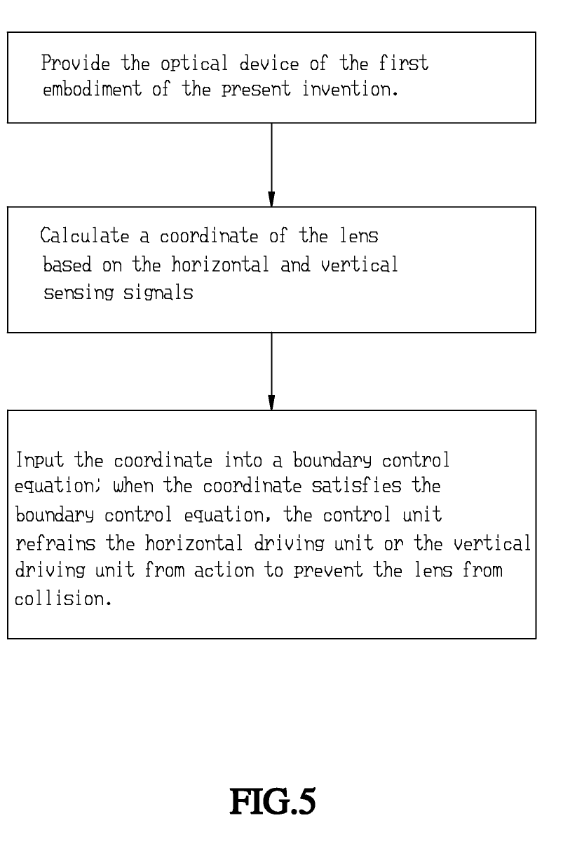

Referring to FIG. 5, a method of moving the lens 110 of the optical device 100 in accordance with a second embodiment of the present invention includes the following steps. First, provide the optical device of the first embodiment of the present invention. Next, calculate a coordinate of the lens 110 based on the horizontal and vertical sensing signals. Finally, input the coordinate into a boundary control equation; when the coordinate satisfies the boundary control equation, the control unit refrains the horizontal driving unit or the vertical driving unit from action to prevent the lens 110 from collision. In light of this, the control unit can control the horizontal driving unit or the vertical driving unit for rotation and rotational direction according to the operation signal to enable the lens 110 to move upward, downward, leftward, or rightward within the safe range.

Considering that it is necessary to position the lens after the optical device is rebooted, the optical device can further include a storage unit electrically connected with the control unit. The control unit can save the coordinate into the storage unit at any time. When the optical device is booted, the control unit captures the coordinate from the storage unit to identify the position of the lens.

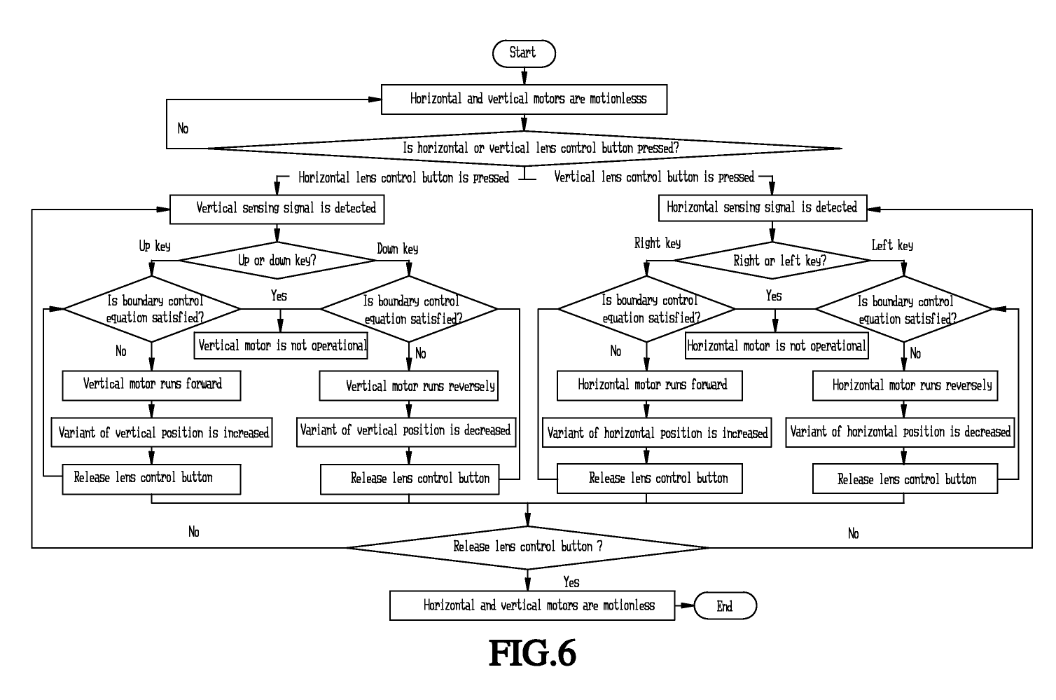

Referring to FIG. 6, when the user presses the up key, the down key, the left key, or the right key, the control unit performs a corresponding action according to the operation signal.

In conclusion, the optical device of the present invention can move the HD glass lens by the DC motor of greater power, it is applicable to the high-end projectors. Besides, the DC motor is preferably low-cost, so the product based on the present invention can be enhanced.

Although the present invention has been described with respect to specific preferred embodiments thereof. it is in no way limited to the specifics of the illustrated structures but changes and modifications may be made within the scope of the appended claims.

What is claimed is:

1. An optical device comprising:
a lens;
a horizontal transmission module connected with the lens;
a vertical transmission module connected with the lens;
a horizontal driving unit connected with the horizontal transmission module for driving the lens to move along a horizontal direction via the horizontal transmission module;
a horizontal orientation detector for detecting horizontal movement amount of the lens and emitting a horizontal sensing signal;
a vertical driving unit connected with the vertical transmission module for driving the lens to move along a vertical direction via the vertical transmission module;
a vertical orientation detector for detecting vertical movement amount of the lens and emitting a vertical sensing signal;
a user interface for emitting an operation signal; and
a control unit electrically connected with the user interface, the horizontal orientation detector, the horizontal driving unit, the vertical orientation detector, and the vertical driving unit;
wherein the control unit controls movement of the lens according to the operation signal, the horizontal sensing unit, and the vertical sensing signal.

2. The optical device as defined in claim 1, wherein the horizontal driving unit comprises a DC motor.

3. The optical device as defined in claim 1, wherein the vertical driving unit comprises a DC motor.

4. The optical device as defined in claim 1, wherein the horizontal orientation detector is a rotary encoder.

5. The optical device as defined in claim 1, wherein the vertical orientation detector is a rotary encoder.

6. The optical device as defined in claim 1, wherein the horizontal orientation detector is connected the horizontal transmission module.

7. The optical device as defined in claim 1, wherein the vertical orientation detector is connected with the vertical transmission module.

8. The optical device as defined in claim 1, wherein the optical device is a projector.

9. The optical device as defined in claim 1, wherein the optical device is a camera.

10. A method of moving a lens comprises steps of:
providing an optical device defined in claim 1;
calculating a coordinate of the lens according to the horizontal sensing signal and the vertical sensing signal; and
inputting the coordinate into a boundary control equation; when the coordinate satisfies the boundary control equation, the control unit refrains the horizontal driving unit or the vertical driving unit from action to prevent the lens from collision.

11. The method as defined in claim 10, wherein the control unit can control the horizontal driving unit or the vertical driving unit for rotation and rotational direction according to the operation signal.

12. The method as defined in claim 10 further comprises a step of providing a storage unit, wherein the storage unit is electrically connected with the control unit; when the optical device is booted, the control unit can capture the coordinate from the storage unit to identify the position of the lens.

13. The method as defined in claim 10, wherein the control unit can add up a variant of horizontal position and the horizontal sensing signal to figure out a horizontal coordinate.

14. The method as defined in claim 10, wherein the control unit can add up a variant of vertical position and the vertical sensing signal to figure out a vertical coordinate of the lens.

15. The method as defined in claim 10, wherein the horizontal sensing signal is a square wave.

16. The method as defined in claim 10, wherein the vertical sensing signal is a square wave.

17. The method as defined in claim 10, wherein the horizontal driving unit comprises a DC motor.

18. The method as defined in claim 10, wherein the vertical driving unit comprises a DC motor.

19. The method as defined in claim 10, wherein the horizontal orientation detector is a rotary encoder.

20. The method as defined in claim 10, wherein the vertical orientation detector is a rotary encoder.

21. The method as defined in claim 10, wherein the horizontal orientation detector is connected with the horizontal transmission module.

22. The method as defined in claim 10, wherein the vertical orientation detector is connected with the vertical transmission module.

23. The method as defined in claim 10, wherein the optical device is a projector.

24. The method as defined in claim 10, wherein the optical device is a camera.
